(19) United States
(12) Patent Application Publication
(10) Pub. No.: US 2017/0054485 A1
(43) Pub. Date: Feb. 23, 2017

(54) FILTER MODULE SUPPORTING CARRIER AGGREGATION AND ELECTRONIC DEVICE INCLUDING THE SAME

(71) Applicant: WISOL CO., LTD., Osan-si (KR)

(72) Inventors: Kyu Han HWANG, Osan-si (KR); Hun Seok LIM, Osan-si (KR)

(21) Appl. No.: 15/211,060

(22) Filed: Jul. 15, 2016

(30) Foreign Application Priority Data
Aug. 19, 2015 (KR) 10-2015-0116975

(51) Int. Cl. H04B 7/06; H04B 1/405

(52) U.S. Cl. CPC H04B 7/068; H04B 1/405

(57) ABSTRACT

A filter module supporting a carrier aggregation (CA) and an electronic device including the same. The electronic device supporting a carrier aggregation may include one or more antennas and a first filter module configured to send or receive signals to and from the first antenna of the one or more antennas. The first filter module may include one or more filter units configured to include a triplexer for transmitting signals having different frequency bands and one or more amplifiers connected to the filter unit and configured to amplify the sent or received signals. Accordingly, according to an embodiment of the present invention, the design process can be more simplified and a cost for implementing a carrier aggregation can be reduced because the carrier aggregation is implemented without a quadplexer.

### CROSS REFERENCE TO RELATED APPLICATION

The present application claims the benefit of Korean Patent Application No. 10-2015-0116975 filed in the Korean Intellectual Property Office on Aug. 19, 2015, the entire contents of which are incorporated herein by reference.

### BACKGROUND OF THE INVENTION

1. Technical Field

The present invention relates to a filter module supporting a carrier aggregation (CA) and an electronic device including the same and, more particularly, to a filter module including one or more antennas and a first filter module for sending and receiving signals to and from a first antenna, wherein the first filter module may include one or more filter units configured to include a triplexer for transmitting signals having different frequency bands and one or more amplifiers connected to the one or more filter units and configured to amplify transmitted and received signal.

2. Description of the Related Art

With the recent development of the communication technology, an available frequency band for wireless communication becomes multiplexed. Accordingly, an electronic device can perform communication using various communication methods and can be implemented in different structures depending on supported communication methods.

In this case, the deployment and connection of parts may be changed depending on a communication method supported by an electronic device. The electronic device requires a space in which parts are deployed because the electronic device may be reduced in size and may be mass-produced. Furthermore, there is a need for a scheme capable of using the same communication method while reducing a manufacturing cost.

In particular, a communication method using a carrier aggregation is recently used. The carrier aggregation refers to a technology for enhancing the transfer rate using two or more frequency bands together.

In order to implement the technology, a quadplexer 110 having a bundle of a total of four filters (transmission filters of two bands and reception filters of two bands) as shown in FIG. 1 is used. The quadplexer is designed so that each filter transmits only a corresponding frequency band and a filtered frequency does not enter the other adjacent filter when one filter filters a specific frequency. Accordingly, the quadplexer is very complicated in the design process and very high in the manufacturing cost. For this reason, the quadplexer is mounted on expensive smart phones only. Accordingly, there is a problem in that the carrier aggregation technology may not be used for middle- and low-price smart phones on which the quadplexer is not mounted.

In order to solve the problem, there has been developed a method using a carrier aggregation even without using the quadplexer using two types of reception filters at the same time in such a manner that a duplexer 221 and 222 each having a bundle of transmission/reception filters of a single band is used in an antenna 211 for sending and receiving middle frequency/low frequency bands and a reception filter 223 of a band different from a band received from the duplexer 221 and 222 is inserted into an antenna 212 for sending and receiving high frequency bands, as shown FIG. 2.

Such a method, however, is not suitable for implementing a carrier aggregation because the reception filter 223 of middle frequency/low frequency bands is inserted into the antenna 212 for sending and receiving high frequency bands. Accordingly, the electronic device of FIG. 2 has a relatively slower speed because it has poor performance compared to a case where a carrier aggregation is implemented using the quadplexer. Furthermore, the quadplexer may use a carrier aggregation while using two transmission bands, whereas the technology of FIG. 2 uses a carrier aggregation while using only a single transmission band. Accordingly, there is another problem in that a carrier aggregation cannot be used if a corresponding transmission band is not used.

### SUMMARY OF THE INVENTION

An embodiment of the present invention is directed to simplifying a design process and reducing a cost by implementing a carrier aggregation without the quadplexer.

Another embodiment of the present invention is direction to implementing a carrier aggregation while increasing the utilization of several transmission bands using a carrier aggregation while using two transmission bands without the quadplexer.

In an embodiment of the present invention, an electronic device supporting a carrier aggregation includes one or more antennas and a first filter module configured to send or receive a signal to and from the first antenna of the one or more antennas. The first filter module may include one or more filter units configured to include a triplexer for transmitting signals having different frequency bands and one or more amplifiers connected to the filter unit and configured to amplify the sent or received signal.

In this case, the filter unit may include a first triplexer, including a first band reception filter for transmitting a signal of a first band reception frequency, a second band reception filter for transmitting a signal of a second band reception frequency, and a second band transmission filter for transmitting a signal of a second band transmission frequency.

In addition, the filter unit may further include a second triplexer, including a first band transmission filter for transmitting a signal of a first band transmission frequency, a first band reception filter for transmitting the signal of the first band reception frequency, and a second band reception filter for transmitting the signal of the second band reception frequency.

The electronic device supporting a carrier aggregation according to an embodiment of the present invention may further include a second filter module configured to receive the signal of the second band reception frequency from the second antenna of the one or more antennas.

Furthermore, at least one of the filter units may further include a first duplexer, including a first band transmission filter for transmitting a signal of a first band transmission frequency and a first band reception filter for transmitting the signal of the first band reception frequency.

The one or more antennas may include a first antenna configured to send or receive a middle or low band frequency and connected to the first filter module and a second antenna configured to send or receive a high band frequency and connected to the second filter module. In this case, the electronic device may further include a first switch configured to control a connection between the antenna and the filter unit.

Furthermore, in an embodiment of the present invention, the electronic device may further include a second switch configured to control a connection between the filter unit and the amplifier. In this case, the electronic device may further include an RF transmission/reception unit configured to process a signal amplified by the amplifier.

In another embodiment of the present invention, an electronic device supporting a carrier aggregation includes a plurality of antennas, a first filter module configured to send or receive the signals of the first antenna of the plurality of antennas, and a second filter module configured to transmit a signal of a second reception band frequency from the second antenna of the plurality of antennas. The first filter module may include one or more filter units configured to include a duplexer for transmitting signals having different frequency bands and one or more amplifiers connected to the filter unit and configured to amplify the sent or received signal.

In this case, at least one of the filter units may be a first duplexer including a first band transmission filter for transmitting a signal of a first band transmission frequency and a first band reception filter for transmitting a signal of a first band reception frequency or may be a second duplexer including a first band reception filter for transmitting a signal of a first band reception frequency and a second band transmission filter for transmitting a signal of a second band transmission frequency.

Furthermore, the plurality of antennas may include a first antenna configured to send or receive a middle or low band frequency and connected to the first filter module and a second antenna configured to send or receive a high band frequency and connected to the second filter module. In this case, the electronic device may further include a first switch configured to control a connection between the antenna and the filter unit.

Furthermore, in an embodiment of the present invention, the electronic device may further include a second switch configured to control a connection between the filter unit and the amplifier. In this case, the electronic device may further include an RF transmission/reception unit configured to process a signal amplified by the amplifier.

In an embodiment of the present invention, the filter module supporting a carrier aggregation may include one or more filter units configured to include a triplexer for transmitting signals having different frequency bands and one or more amplifiers connected to the filter unit and configured to amplify sent or received signals.

In this case, at least one of the filter units may include a first triplexer, including a first band reception filter for transmitting a signal of a first band reception frequency, a second band reception filter for transmitting a signal of a second band reception frequency, and a second band transmission filter for transmitting a signal of a second band transmission frequency. In this case, the filter unit may further include a second triplexer, including a first band transmission filter for transmitting a signal of a first band transmission frequency, a first band reception filter for transmitting the signal of the first band reception frequency, and a second band reception filter for transmitting the signal of the second band reception frequency.

Furthermore, the filter module may further include a first switch configured to control a connection between the antenna and the filter unit.

### BRIEF DESCRIPTION OF THE DRAWINGS

FIG. 1 shows the function blocks of an electronic device supporting a carrier aggregation using a conventional quadplexer.

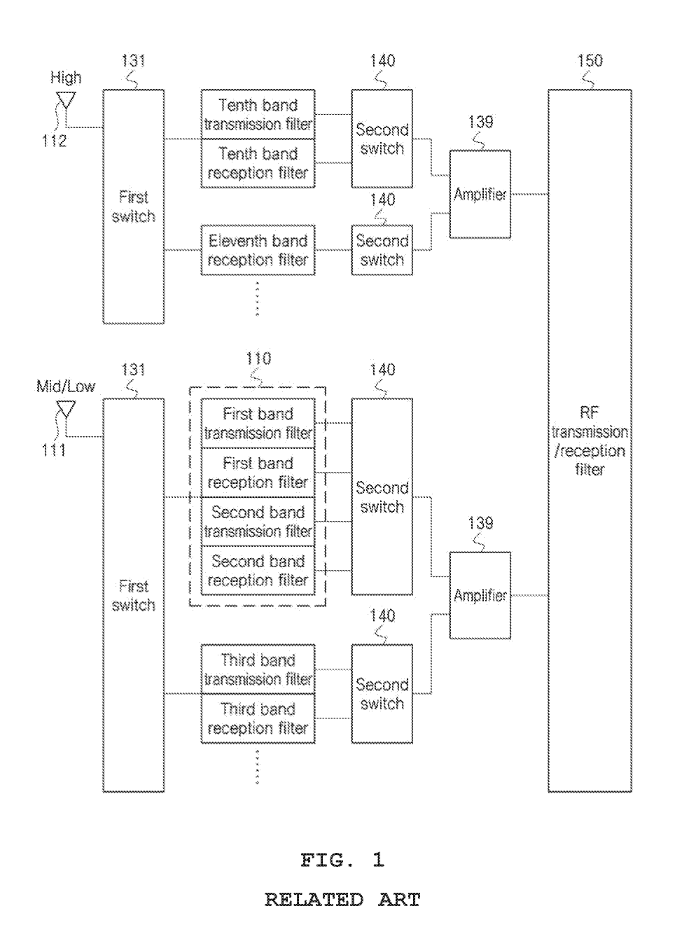

FIG. 2 shows the function blocks of an electronic device supporting a carrier aggregation by inserting a filter of the middle frequency/low frequency bands into a high frequency antenna without a conventional quadplexer.

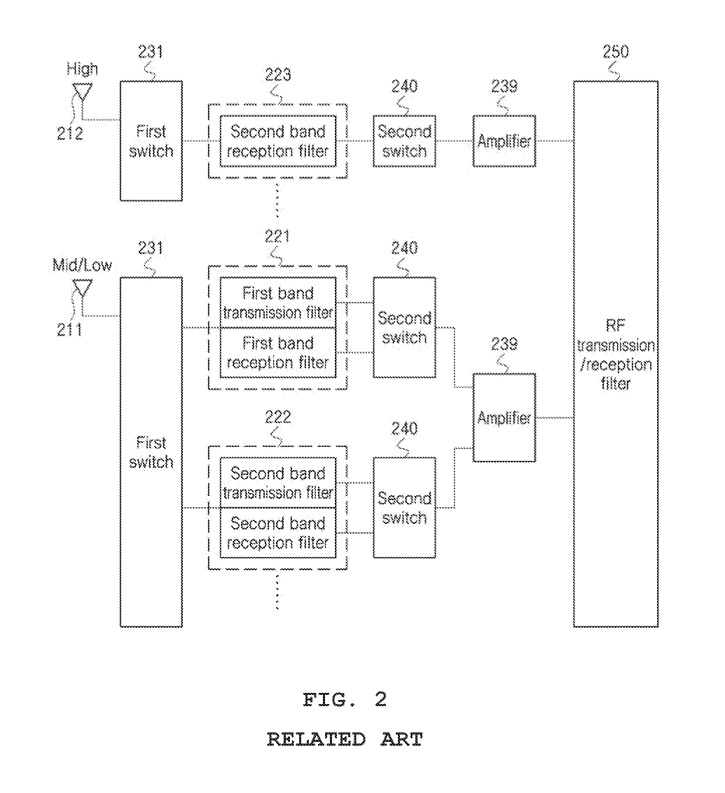

FIG. 3 shows the function blocks of an electronic device supporting a carrier aggregation according to a first embodiment of the present invention.

FIG. 4 shows the function blocks of an electronic device supporting a carrier aggregation according to a second embodiment of the present invention.

FIG. 5 shows the function blocks of an electronic device supporting a carrier aggregation according to a third embodiment of the present invention.

FIG. 6A is a construction diagram showing the function blocks of a filter module supporting a carrier aggregation according to an embodiment of the present invention.

FIG. 6B is a circuit diagram showing the configuration of the filter module supporting a carrier aggregation according to an embodiment of the present invention.

### DETAILED DESCRIPTION

Hereinafter, embodiments of the present invention are described in detail with reference to the accompanying drawings.

Some embodiments described in the detailed description of the present invention are illustrative for better understanding, and the scope of the present invention is not intended to be restricted by the embodiments.

Functional blocks illustrated in the drawings and described hereunder are only examples of possible implementations. In other implementations, other functional blocks may be used without departing from the spirit and scope of the detailed description. Furthermore, one or more functional blocks of the present invention are illustrated as separate blocks, but one or more of the functional blocks of the present invention may be a combination of various hardware and software elements for executing the same function.

Furthermore, it should be understood that an expression that some elements are “included” is an expression of an “open type” and the expression simply denotes that the corresponding elements are present, but does not exclude additional elements.

Furthermore, when one element is described as being “connected” or “coupled” to the other element, it should be understood that one element may be directly connected or coupled to the other element, but a third element may be interposed between the two elements.

Furthermore, expressions, such as the first and the second, are used to only distinguish a plurality of elements from one another, but they do not limit a sequence or other characteristics between them.

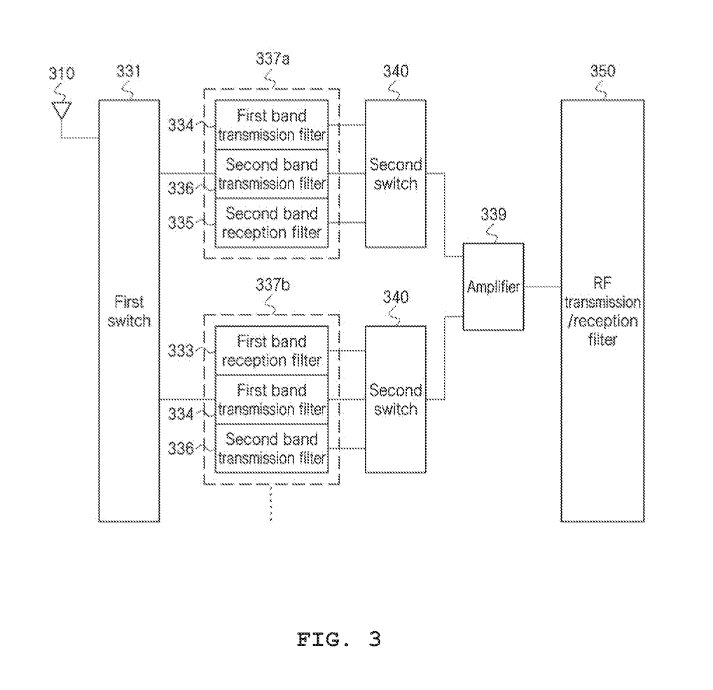

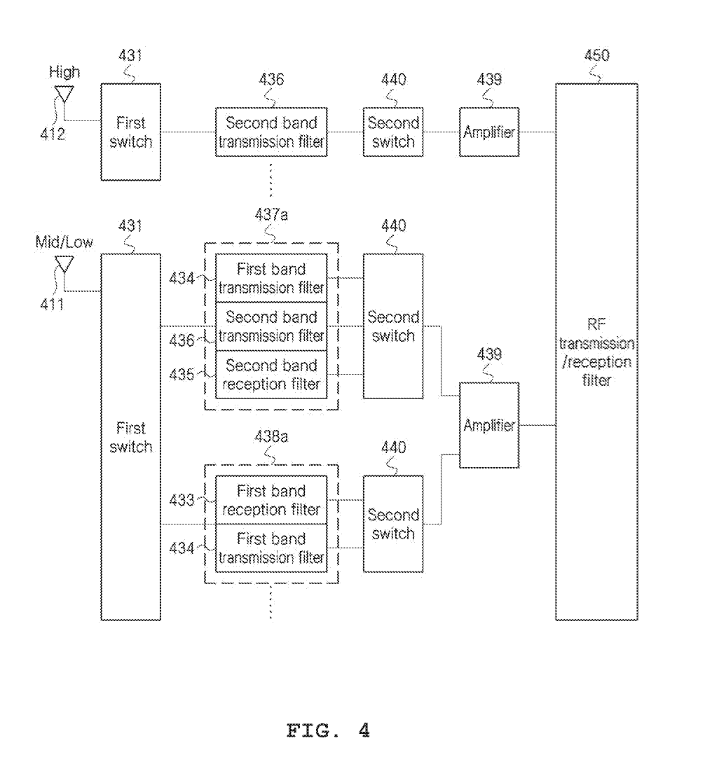

FIGS. 3 and 4 show the function blocks of electronic devices supporting a carrier aggregation according to embodiments of the present invention.

Referring to FIG. 3, the electronic device supporting a carrier aggregation according to an embodiment of the present invention includes an antenna 310 and a first filter module. The first filter module may include one or more filter units configured to include triplexers 337a and 337b for transmitting signals having different frequency bands and one or more amplifiers 339 connected to the filter units and configured to amplify sent or received signals.

The antenna 310 receives a radio signal from the air. The antenna 310 may receive a radio signal of a predetermined frequency band and may receive a radio signal in a frequency band of a supported communication method.

In general, the filter module may receive a radio signal from the antenna and may perform pre-processing on the radio signal or separate a predetermined frequency band from the radio signal. In this case, the filter module may have predetermined frequency bands, and the frequency bands may be different.

The first filter module according to an embodiment of the present invention may include the filter unit and the amplifier 339. The filter unit may include one or more filters for transmitting a specific signal. In this case, the frequency bands which may pass through the filters may be different, and any one of the filter units may be selected by a first switch to be described later and may receive a radio signal received by the antenna 310.

In particular, at least one of the filter units may include the triplexers 337a and 337b for transmitting signals having different frequency bands. The triplexer includes a first filter connected to the antenna and configured to transmit a signal of a first band frequency, a second filter connected to the antenna and configured to transmit a signal of a second band frequency, a third filter connected to the antenna and configured to transmit a signal of a third band frequency, and a matching element coupled between the antenna and the ground and configured to match impedance between the antenna and a reception stage and between the antenna and a transmission stage. At least two of the first to the third filters may implement a carrier aggregation using different frequency bands at the same time. In this case, at least two of the first to the third filters may receive signals of different reception frequency bands at the same time. Accordingly, a reception speed can be improved using two different frequency bands at the same time. In particular, the first filter may be a reception filter for transmitting the signal of the first band reception frequency from the antenna to the reception stage. The second filter may be a reception filter for transmitting the signal of the second band reception frequency from the antenna to the reception stage. The third filter may be a transmission filter for transmitting the signal of the transmission frequency to the antenna. Accordingly, the design process can be simplified and a cost for implementing a carrier aggregation can be reduced because the carrier aggregation can be implemented without a quadplexer by receiving the first band reception frequency and the second band reception frequency at the same time.

In this case, a surface acoustic wave (SAW) filter or a notch filter may be used as the filter according to an embodiment of the present invention. The notch filter is characterized in that it is difficult for the notch filter to transmit a specific frequency band and the notch filter does not transmit a portion that belongs to a band reject filter (BRF) and that has a very narrow region.

The SAW is an acoustic wave propagated along a surface of an elastic substrate. An acoustic wave is generated from an electronic signal as the results of a piezoelectric effect. In this case, the electric field of the acoustic wave is concentrated on a portion near the surface of the elastic substrate, and may interact with the conductive electrons of another semiconductor placed on the surface. A medium for minimizing an energy loss within a system may be selected by physically separating the semiconductor and the substrate to which the acoustic wave is propagated. The SAW filter is obtained by substituting an electronic circuit with an electromechanical element using an interaction between the conductive electrons of the semiconductor and the SAW having such a characteristic. The SAW filter may be applied as an RF or IF filter chip for providing frequency selectivity, and may function to transmit a required frequency and to remove an unnecessary frequency.

The amplifier 339 is connected to the filter unit and amplifies a sent or received signal. In this case, the amplifier may be a low noise amplifier (LNA). The LNA is high frequency amplifier adapted to reduce the noise index of the entire receiver and is used to amplify a weak signal in a communication link having a great propagation loss.

Furthermore, at least one of the filter units may be the first triplexer 337a including a first band reception filter 334 for transmitting the signal of the first band reception frequency, a second band reception filter 336 for transmitting the signal of the second band reception frequency, and a second band transmission filter 335 for transmitting the signal of the second band transmission frequency. Accordingly, the design process can be simplified and a cost for implementing a carrier aggregation can be reduced because the carrier aggregation can be implemented without a quadplexer by receiving the first band reception frequency and the second band reception frequency at the same time.

In this case, the bandpass bands of the first band reception filter 334, the second band reception filter 336, and the second band transmission filter 335 may not interfere with each other. The reason for this is that the filters can send or receive respective signals independently although the signals are inputted to the filter module through a single input port. As a result, the transmission characteristics and transmission efficiency of signals processed by the respective filters within the filter module can be improved, and a communication signal of a specific required band can be effectively selected and used.

Expressions, such as “the first” and “the second”, are used to only distinguish a plurality of elements from one another and do not limit the sequence or other characteristics between the elements. For example, the first band may denote B1 (e.g., 2.1 GHz), and the second band may denote B3 (e.g., 1.8 GHz). In contrast, the first band may denote B3 (e.g., 1.8 GHz), and the second band may denote B1 (e.g., 2.1 GHz). In addition, the first band and the second band may include all of combinations capable of a carrier aggregation as shown in Table 1 below. Some embodiments of the combinations capable of a carrier aggregation and supported bandwidths according to the combinations are shown in Table 1.

TABLE 1

| | Carrier Frequency | Max. |
|---|---|---|
| Band | G: GHz | aggregated |
| Combination | M: MHz | BW [MHz] |
| B7 + B7 | 2.6 G + 2.6 G | 40 |
| B38 + B38 | 2.6 G + 2.6 G | 40 |
| B41 + B41 | 2.5 G + 2.5 G | 40 |
| B25 + B25 | 1.9 G + 1.9 G | 20 |
| B41 + B41 | 2.5 G + 2.5 G | 40 |
| B4 + B13 | 2.1 G + 700 M | 30 |
| B7 + B20 | 2.6 G + 800 M | 30 |
| B1 + B19 | 2.1 G + 800 M | 35 |
| B3 + B5 | 1.8 G + 800 M | 30 |
| B1 + B18 | 2.1 G + 800 M | 35 |
| B4 + B5 | 1.7 G + 800 M | 20 |
| B3 + B20 | 1.8 G + 800 M | 30 |
| B2 + B17 | 1.9 G + 700 M | 20 |
| B2 + B29 | 1.9 G + 700 M | 20 |
| B4 + B29 | 2.1 G + 700 M | 20 |
| B4 + B17 | 2.1 G + 700 M | 20 |
| B4 + B12 | 2.1 G + 700 M | 20 |
| B3 + B8 | 1.8 G + 900 M | 30 |
| B3 + B7 | 1.7 G + 2.6 G | 40 |
| B5 + B12 | 800 M + 700 M | 20 |
| B4 + B7 | 1.7 G + 2.6 G | 30 |
| B5 + B17 | 800 M + 700 M | 20 |
| B8 + B20 | 900 M + 800 M | 20 |
| B11 + B18 | 1.4 G + 800 M | 25 |
| B1 + B21 | 2.1 G + 1.4 G | 35 |

Furthermore, if at least one of the filter units is the first triplexer 337a including the first band reception filter 334 for transmitting the signal of the first band reception frequency, the second band reception filter 336 for transmitting the signal of the second band reception frequency, and the second band transmission filter 335 for transmitting the signal of the second band transmission frequency, the other of the filter units may be the second triplexer 337b including a first band transmission filter 333 for transmitting a signal of a first band transmission frequency, a first band reception filter 334 for transmitting the signal of the first band reception frequency, and a second band reception filter 336 for transmitting the signal of the second band reception frequency.

Accordingly, while a carrier aggregation is implemented by receiving the first band reception frequency and the second band reception frequency at the same time, a signal may be sent in the first band or the second band. Accordingly, one of the two bands may be selected and a signal may be sent in the selected band in either an area where transmission is unstable in the first band or an area where transmission is unstable in the second band and at the same time, a carrier aggregation can be performed.

FIG. 4 shows the function block of an electronic device supporting a carrier aggregation according to an embodiment of the present invention.

Referring to FIG. 4, the electronic device supporting a carrier aggregation according to an embodiment of the present invention may further include a second filter module for receiving a second band reception frequency from an antenna. In this case, the second filter module may include a filter unit configured to transmit a signal having a second frequency band and one or more amplifiers 439 connected to the filter unit and configured to amplify sent or received signals.

When a first filter module receives a first band reception frequency, the second filter module functions to implement a carrier aggregation by receiving the second band reception frequency at the same time. Accordingly, the first filter module and the second filter module may be connected to different antennas.

In this case, at least one of the filter units of the first filter module may be a first duplexer 438a including a first band transmission filter 433 for transmitting a signal of a first band transmission frequency and a first band reception filter 434 for transmitting a signal of a first band reception frequency. Accordingly, the design process can be simplified and a cost for implementing a carrier aggregation can be reduced because the carrier aggregation can be implemented without a quadplexer in such a manner that the first filter module receives the first band reception frequency and at the same time, the second filter module receives the second band reception frequency.

Furthermore, in this case, one of the filter units of the first filter module may further include a first triplexer 437a including a first band reception filter 434 for transmitting a signal of a first band reception frequency, a second band reception filter 436 for transmitting a signal of a second band reception frequency, and a second band transmission filter 435 for transmitting a signal of a second band transmission frequency.

Accordingly, while a carrier aggregation is implemented by receiving the first band reception frequency and the second band reception frequency at the same time, a signal may be sent in the first band or the second band. Accordingly, one of the two bands may be selected and a signal may be sent in the selected band in either an area where transmission is unstable in the first band or an area where transmission is unstable in the second band and at the same time, a carrier aggregation can be performed.

Furthermore, the antenna may include a first antenna 411 configured to send or receive a middle or low band frequency and connected to the first filter module and a second antenna 412 configured to send or receive a high band frequency and connected to the second filter module. Accordingly, when the first filter module receives the first band reception frequency, the second filter module receives the second band reception frequency at the same time. Accordingly, a carrier aggregation can be implemented without a quadplexer.

Furthermore, the electronic device supporting a carrier aggregation according to an embodiment of the present invention may further include a first switch 431 for controlling a connection between the antenna and the filter unit. The first switch 431 operates in response to a control signal indicating that a signal received from the antenna will pass through which filter module. Accordingly, whether a signal will be sent in the first band or the second band can be selected.

The electronic device supporting a carrier aggregation according to an embodiment of the present invention may further include a second switch 440 for controlling a connection between the filter unit and the amplifier.

In the filter module, the output stage of the reception filter may be connected to the second switch 440 in order to control how a signal passing through which filter will be amplified and sent to an RF transmission/reception unit 450. Reception data passing through the second switch is amplified by the amplifier and transferred to the RF transmission/reception unit 450. If several frequency bands passing through the filter unit do not overlap, the output stage of the filter unit may output signals of several frequencies at once through a single terminal so that the signals are amplified.

Furthermore, the input stage of the transmission filter for sending a signal sent by the RF transmission/reception unit 450 may be connected to the second switch 440 and may control that a signal passing through the amplifier will be sent to the antenna through which filter. Accordingly, transmission data sent by the RF transmission/reception unit 450 is amplified by the amplifier 439 and sent to the outside through the antenna via a filter selected by the second switch 440.

The electronic device supporting a carrier aggregation according to an embodiment of the present invention may further include the RF transmission/reception unit 450 for processing a signal amplified by the amplifier. The RF transmission/reception unit 450 may convert a radio signal into an electrical signal. To this end, the RF transmission/reception unit may include at least any one of a transceiver, a receiver, an amplifier, and a mixer.

Accordingly, a carrier aggregation can be implemented by selecting a method for sending a signal in the first band transmission frequency while receiving the first band reception frequency and second band reception frequency passing through the filter unit at the same time or a method for sending a signal in the second band transmission frequency while receiving the first band reception frequency and the second band reception frequency at the same time. In this case, one of the two bands may be selected and a signal may be sent in the selected band in either an area where transmission is unstable in the first band or an area where transmission is unstable in the second band and at the same time, a carrier aggregation can be performed.

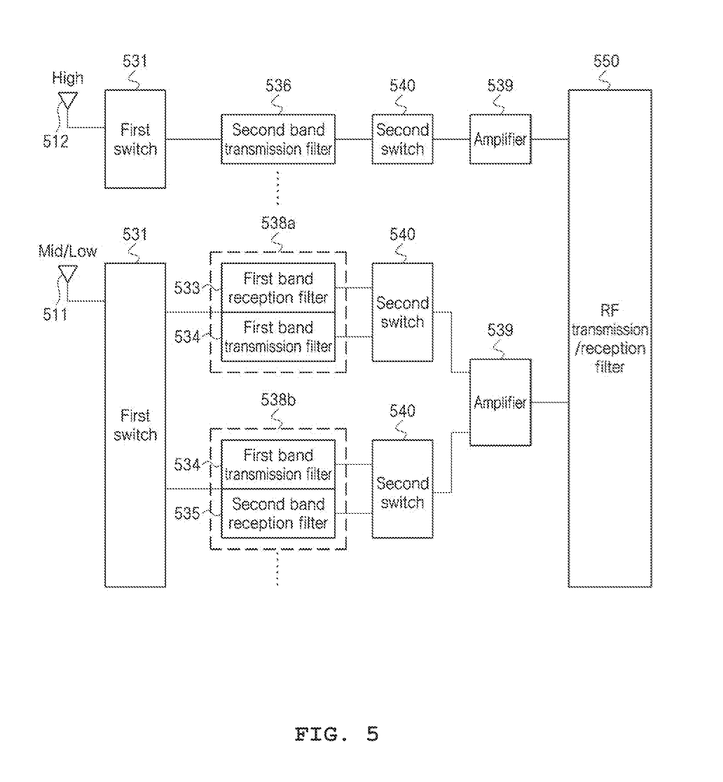

FIG. 5 shows the function blocks of an electronic device supporting a carrier aggregation according to an embodiment of the present invention.

Referring to FIG. 5, the electronic device supporting a carrier aggregation according to an embodiment of the present invention includes a plurality of antennas, a first filter module for sending and receiving signals to and from the first antenna 511 of the plurality of antennas, and a second filter module for transmitting a signal of a second reception band frequency from a second antenna 512. The first filter module may include one or more filter units configured to include a duplexer for transmitting signals having different frequency bands and one or more amplifiers 539 connected to the filter unit and configured to amplify sent or received signals.

The first antenna 511 or the second antenna 512 may receive a radio signal from the air. The first antenna 511 or the second antenna 512 may receive a radio signal of a predetermined frequency band and may receive a radio signal in a frequency band of a supported communication method.

The filter module may receive a radio signal from the antenna and may perform pre-processing on the radio signal or separate a predetermined frequency band from the radio signal. In this case, the filter module may have predetermined frequency bands, and the frequency bands may be different.

The first filter module may include the filter unit and the amplifier 539. The filter unit may include one or more filters for transmitting a specific signal. In this case, frequency bands capable of passing through the filters may be different. Any one of the filter units may be selected by a first switch 531 to be described later, and may receive a radio signal received by the antenna.

In this case, the second filter module may include a filter unit configured to transmit a signal of a second frequency band and the one or more amplifiers 539 connected to the filter unit and configured to amplify sent or received signals. When the first filter module receives the first band reception frequency, the second filter module functions to implement a carrier aggregation by receiving the second band reception frequency at the same time. Accordingly, the first filter module and the second filter module may be connected to different antennas.

The amplifier 539 is connected to the filter unit and amplifies a sent or received signal. In this case, the amplifier may include a low noise amplifier (LNA). The LNA is a high frequency the amplifier adapted to reduce the noise index of the entire receiver, and is used to amplify a weak signal in a communication link having a great propagation loss.

At least one of the filter units of the first filter module may be a first duplexer 538a including a first band transmission filter 533 for transmitting a signal of a first band transmission frequency and a first band reception filter 534 for transmitting a signal of a first band reception frequency.

Accordingly, the design process can be simplified and a cost for implementing a carrier aggregation can be reduced because the carrier aggregation can be implemented without a quadplexer in such a manner that the first filter module receives the first band reception frequency and at the same time, the second filter module receives the second band reception frequency.

In addition, at least one of the filter units of the first filter module may be a second duplexer 538b including a first band reception filter 534 for transmitting a signal of a first band reception frequency and a second band transmission filter 535 for transmitting a signal of a second band transmission frequency.

In this case, the design process can be simplified and a cost for implementing a carrier aggregation can be reduced because the carrier aggregation can be implemented without a quadplexer in such a manner that the first filter module receives the first band reception frequency and at the same time, the second filter module receives the second band reception frequency.

Furthermore, the plurality of antennas may include the first antenna 511 configured to send or receive a middle or low band frequency and connected to the first filter module and the second antenna 512 configured to send or receive a high band frequency and connected to the second filter module. Accordingly, when the first filter module receives the first band reception frequency, the second filter module receives the second band reception frequency at the same time, thereby being capable of implementing a carrier aggregation even without a quadplexer.

The electronic device supporting a carrier aggregation according to an embodiment of the present invention may further include the first switch 531 for controlling a connection between the antenna and the filter unit. The first switch 531 controls that a signal received from the antenna will pass through which filter module. Accordingly, how a signal will be sent in the first band or the second band while a carrier aggregation is implemented can be selected.

The electronic device supporting a carrier aggregation according to an embodiment of the present invention may further include a second switch 540 for controlling a connection between the filter unit and the amplifier 539.

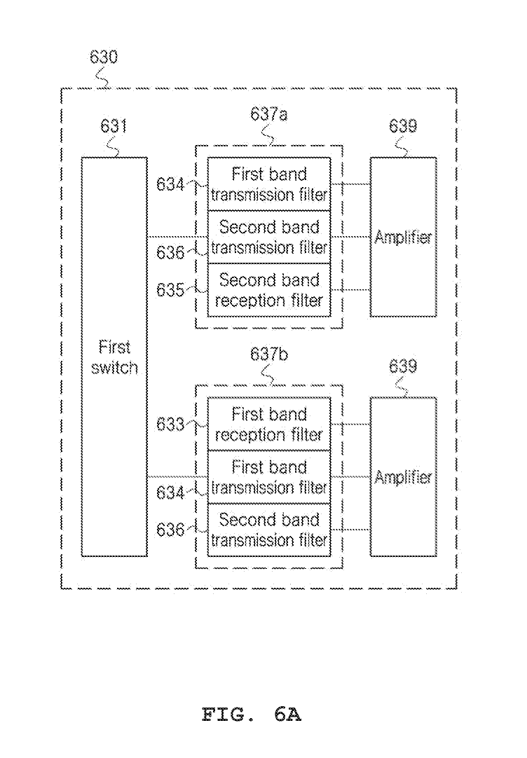

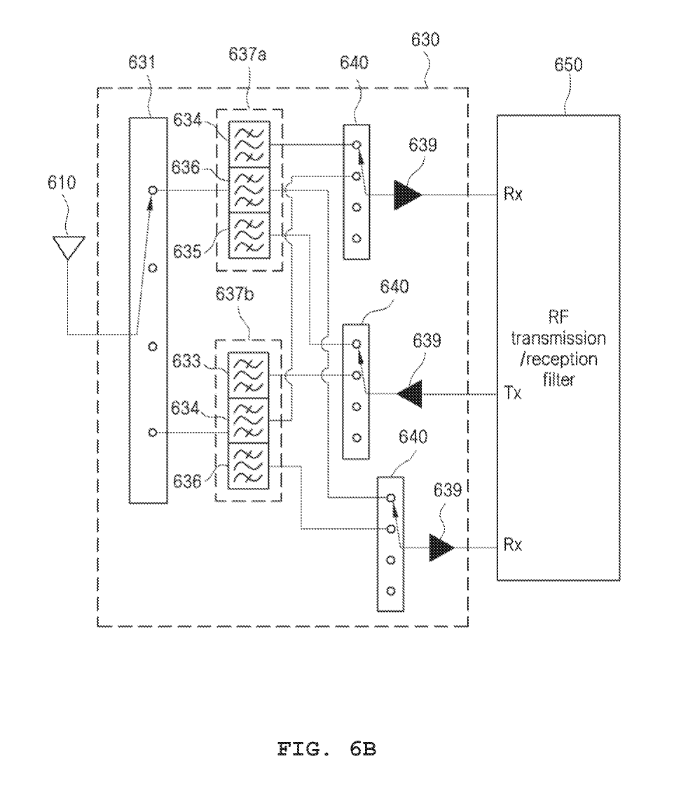

Referring to FIG. 6B, the output stage of a reception filter for receiving a signal from a filter module 630 may be connected to the second switch, and may control that a signal passing through which filter will be amplified and sent to the RF transmission/reception unit. Accordingly, since a filter which will receive reception data is selected by the second switch, the reception data passing through the second switch is amplified by the amplifier and transferred to the RF transmission/reception unit. If several frequency bands passing through the filter unit do not overlap, the output stage of the filter unit may output signals of several frequencies at once through a single terminal so that the signals are amplified.

Furthermore, the input stage of the transmission filter for sending a signal sent by the RF transmission/reception unit may be connected to the second switch in order to control that a signal passing through the amplifier passes through which filter and will be sent to the antenna. Accordingly, transmission data sent by the RF transmission and reception unit is amplified by the amplifier. The transmission data passes through a filter selected by the second switch, and is then sent to the outside through the antenna.

The electronic device supporting a carrier aggregation according to an embodiment of the present invention may further include the RF transmission/reception unit for processing a signal amplified by the amplifier. The RF transmission/reception unit may convert a radio signal into an electrical signal. To this end, the RF transmission/reception unit may include at least any one of a transceiver, a receiver, an amplifier, and a mixer.

Accordingly, a carrier aggregation can be implemented by selecting a method for sending a signal in the first band transmission frequency while receiving the first band reception frequency and the second band reception frequency passing through the filter unit at the same time or a method for sending a signal in the second band transmission frequency while receiving the first band reception frequency and the second band reception frequency at the same time.

In this case, one of the two bands may be selected and a signal may be sent in the selected band in either an area where transmission is unstable in the first band or an area where transmission is unstable in the second band and at the same time, a carrier aggregation can be performed.

FIGS. 6A and 6B show the function blocks and circuit configuration of the filter module 630 supporting a carrier aggregation according to an embodiment of the present invention.

Referring to FIGS. 6A and 6B, the filter module 630 may include one or more filter units configured to include triplexers 637a and 637b for transmitting signals having different frequency bands and one or more amplifiers 639 connected to the filter unit and configured to amplify sent or received signals.

The filter module supporting a carrier aggregation may receive a radio signal from an antenna and may perform pre-processing on the radio signal or separate a predetermined frequency band from the radio signal. In this case, the filter module may have predetermined frequency bands, and the frequency bands may be different.

The filter module may include the filter unit and the amplifiers 639. The filter unit may include one or more filters for transmitting a specific signal. In this case, frequency bands capable of passing through the filters may be different. Any one of the filter units may be selected by a first switch 631 to be described later, and may receive a radio signal received by the antenna.

In particular, at least one of the filter units may include the triplexers 637a and 637b for transmitting signals having different frequency bands. The triplexer includes a first filter connected to the antenna and configured to transmit a signal of a first band frequency, a second filter connected to the antenna and configured to transmit a signal of a second band frequency, a third filter connected to the antenna and configured to transmit a signal of a third band frequency, and a matching element coupled between the antenna and the ground and configured to match impedance between the antenna and a reception stage and between the antenna and a transmission stage. At least two of the filters may implement a carrier aggregation using different frequency bands at the same time. In this case, at least two of the filters may receive signals of different reception frequency bands at the same time. Accordingly, a reception speed can be improved using two different frequency bands at the same time. In particular, the first filter may be a reception filter for transmitting the signal of the first band reception frequency from the antenna to the reception stage. The second filter may be a reception filter for transmitting the signal of the second band reception frequency from the antenna to the reception stage. The third filter may be a transmission filter for transmitting the signal of the transmission frequency to the antenna. Accordingly, the design process can be simplified and a cost for implementing a carrier aggregation can be reduced because the carrier aggregation can be implemented without a quadplexer by receiving the first band reception frequency and the second band reception frequency at the same time.

The amplifier 639 is connected to the filter unit and amplifies sent or received signals. In this case, the amplifier may include a low noise amplifier (LNA). The LNA is a high frequency amplifier adapted to reduce the noise index of the entire receiver, and is used to amplify a weak signal in a communication link having a great propagation loss.

At least one of the filter units may be the first triplexer 637a including a first band reception filter 634 for transmitting the signal of the first band reception frequency, a second band reception filter 636 for transmitting the signal of the second band reception frequency, and a second band transmission filter 635 for transmitting the signal of the second band transmission frequency. Accordingly, the design process can be simplified and a cost for implementing a carrier aggregation can be reduced because the carrier aggregation can be implemented without a quadplexer by receiving the first band reception frequency and the second band reception frequency at the same time.

In this case, the bandpass bands of the first band reception filter 634, the second band reception filter 636, and the second band transmission filter 635 may interfere with each other. The reason for this is that the filters can send or receive respective signals independently although the signals are inputted to the filter module through a single input port. As a result, the transmission characteristics and transmission efficiency of signals processed by the respective filters within the filter module can be improved, and a communication signal of a specific and required band can be effectively selected and used.

Furthermore, if at least one of the filter units is the first triplexer 637a including the first band reception filter 634 for transmitting the signal of the first band reception frequency, the second band reception filter 636 for transmitting the signal of the second band reception frequency, and the second band transmission filter 635 for transmitting the signal of the second band transmission frequency, the other of the filter units may be a second triplexer 637b including a first band transmission filter 633 for transmitting a signal of a first band transmission frequency, a first band reception filter 634 for transmitting a signal of a first band reception frequency, and a second band reception filter 636 for transmitting a signal of a second band reception frequency.

Accordingly, while a carrier aggregation is implemented by receiving the first band reception frequency and the second band reception frequency at the same time, a signal may be sent in the first band or the second band. In this case, one of the two bands may be selected and a signal may be sent in the selected band in either an area where transmission is unstable in the first band, or an area where transmission is unstable in the second band and at the same time, a carrier aggregation can be performed.

The filter module according to an embodiment of the present invention may further include the first switch for controlling a connection between the antenna and the filter unit. The first switch controls that a signal received from the antenna will pass through which filter module. Accordingly, while a carrier aggregation is implemented, whether a signal will be sent in the first band or the second band can be selected.

The filter module supporting a carrier aggregation according to an embodiment of the present invention may further include a second switch for controlling a connection between the filter unit and the amplifier 639.

Referring to FIG. 6B, the output stage of the reception filter which receives a signal from the filter module may be connected to the second switch 640 in order to control that a signal passing through which filter will be amplified and sent to the RF transmission/reception unit 650. Accordingly, since a filter which will receive reception data is selected by the second switch 640, reception data passing through the second switch 640 is amplified by the amplifier 639 and transferred to the RF transmission/reception unit 650. If several frequency bands passing through the filter unit do not overlap, the output stage of the filter unit may output signals of several frequencies at once through a single terminal so that the signals are amplified.

Furthermore, the input stage of the transmission filter which sends a signal transmitted by the RF transmission/reception unit 650 may be connected to the second switch 640 in order to control that a signal passing through the amplifier 639 will be sent to the antenna through which filter. Accordingly, transmission data sent by the RF transmission/reception unit 650 is amplified by the amplifier 639 and sent to the outside through the antenna via a filter selected by the second switch 640.

In an embodiment of the present invention, the design process can be simplified and a cost for implementing a carrier aggregation can be reduced because the carrier aggregation can be implemented without a quadplexer.

Furthermore, in an embodiment of the present invention, the utilization of several transmission bands can be improved and a carrier aggregation can be implemented because two transmission bands are used without a quadplexer and a carrier aggregation is used.

Although the embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An electronic device supporting a carrier aggregation, comprising:
one or more antennas; and
a first filter module configured to send or receive a signal to and from a first antenna of the one or more antennas,
wherein the first filter module comprises:
one or more filter units configured to comprise a triplexer for transmitting signals having different frequency bands, and
one or more amplifiers connected to the filter unit and configured to amplify the sent or received signal.

2. The electronic device of claim 1, wherein the filter unit comprises a first triplexer, wherein the first triplexer comprises:
a first band reception filter for transmitting a signal of a first band reception frequency;
a second band reception filter for transmitting a signal of a second band reception frequency; and
a second band transmission filter for transmitting a signal of a second band transmission frequency.

3. The electronic device of claim 2, wherein the filter unit further comprises a second triplexer, wherein the second triplexer comprises:
a first band transmission filter for transmitting a signal of a first band transmission frequency;
a first band reception filter for transmitting the signal of the first band reception frequency; and
a second band reception filter for transmitting the signal of the second band reception frequency.

4. The electronic device of claim 2, further comprising a second filter module configured to receive the signal of the second band reception frequency from a second antenna of the one or more antennas.

5. The electronic device of claim 4, wherein the filter unit further comprises a first duplexer, wherein the first duplexer comprises:
a first band transmission filter for transmitting a signal of a first band transmission frequency; and
a first band reception filter for transmitting the signal of the first band reception frequency.

6. The electronic device of claim 4, wherein the one or more antennas comprise:
a first antenna configured to send or receive a middle or low band frequency and connected to the first filter module; and
a second antenna configured to send or receive a high band frequency and connected to the second filter module.

7. The electronic device of claim 1, further comprising a first switch configured to control a connection between the antenna and the filter unit.

8. The electronic device of claim 1, further comprising a second switch configured to control a connection between the filter unit and the amplifier.

9. The electronic device of claim 1, further comprising an RF transmission/reception unit configured to process a signal amplified by the amplifier.

10. An electronic device supporting a carrier aggregation, comprising:
a plurality of antennas;
a first filter module configured to send or receive signals of a first antenna of the plurality of antennas; and
a second filter module configured to transmit a signal of a second reception band frequency from a second antenna of the plurality of antennas,
wherein the first filter module comprises:
one or more filter units configured to comprise a duplexer for transmitting signals having different frequency bands; and
one or more amplifiers connected to the filter unit and configured to amplify the sent or received signals.

11. The electronic device of claim 10, wherein the filter unit comprises a first duplexer, wherein the first duplexer comprises:
a first band transmission filter for transmitting a signal of a first band transmission frequency; and
a first band reception filter for transmitting a signal of a first band reception frequency.

12. The electronic device of claim 10, wherein the filter unit comprises a second duplexer, wherein the second duplexer comprises:
a first band reception filter for transmitting a signal of a first band reception frequency; and
a second band transmission filter for transmitting a signal of a second band transmission frequency.

13. The electronic device of claim 11, wherein the plurality of antennas comprise:
a first antenna configured to send or receive a middle or low band frequency and connected to the first filter module; and
a second antenna configured to send or receive a high band frequency and connected to the second filter module.

14. The electronic device of claim 10, further comprising a first switch configured to control a connection between the antenna and the filter unit.

15. The electronic device of claim 10, further comprising a second switch configured to control a connection between the filter unit and the amplifier.

16. The electronic device of claim 10, further comprising an RF transmission/reception unit configured to process a signal amplified by the amplifier.

17. A filter module supporting a carrier aggregation, comprising:
one or more filter units configured to comprise a triplexer for transmitting signals having different frequency bands; and
one or more amplifiers connected to the filter unit and configured to amplify sent or received signals.

18. The filter module of claim 17, wherein the filter unit comprises a first triplexer, wherein the first triplexer comprises:
a first band reception filter for transmitting a signal of a first band reception frequency;
a second band reception filter for transmitting a signal of a second band reception frequency; and
a second band transmission filter for transmitting a signal of a second band transmission frequency.

19. The filter module of claim 18, wherein the filter unit further comprises a second triplexer, wherein the second triplexer comprises:
a first band transmission filter for transmitting a signal of a first band transmission frequency;
a first band reception filter for transmitting the signal of the first band reception frequency; and
a second band reception filter for transmitting the signal of the second band reception frequency.

20. The filter module of claim 17, further comprising a first switch configured to control a connection between the antenna and the filter unit.
